(19) United States
(12) Patent Application Publication
(10) Pub. No.: US 2003/0152065 A1
(43) Pub. Date: Aug. 14, 2003

(54) Integrated IP network telephone distributor with switching and routing functions

(75) Inventors: Chih-Sheng Chang, Taipei (TW); Wumin Chen, Taipei (TW)

Correspondence Address: BACON & THOMAS, PLLC, 625 SLATERS LANE, FOURTH FLOOR, ALEXANDRIA, VA, 22314

(73) Assignee: Institute For Information Industry, Taipei (TW)

(21) Appl. No.: 10/067,896

(22) Filed: Feb. 8, 2002

(51) Int. Cl. H04L 12/66; H04L 12/28

(52) U.S. Cl. 370/352; 370/401

(57) ABSTRACT

An integrated IP network telephone distributor with switching and routing functions is disclosed. A packet classifying device performs a packet classifying process to the network packets received from a network for classifying the network packets into voice package or data package. The voice packet is sent to a voice processing circuit to be transformed into voice signal for output, while the data packet is sent to a connected personal computer.

### BACKGROUND OF THE INVENTION

1. Field of the Invention

The present invention relates to an IP network telephone, and more particularly to an integrated IP network telephone distributor with switching and routing functions.

2. Description of Related Art

An IP (Internet Protocol) network telephone is a product resulting from the combination of circuit switch and package switch. In general, an IP network telephone is connected to a network through an RJ-45 wire. Other than being communicated with other IP network telephones connected to the network, the IP network telephone can be communicated with the conventional Public Switched Telephone Network (PSTN) through an IP telephone Gateway (ITG).

Typically, other network devices are required in the network environment for accessing the network, such as a personal computer. Therefore, one IP network telephone and one personal computer require two RJ-45 network wires and occupy two ports on the Hub or network switching device. However, this is not cost-effective. If a plurality of personal computers or IP network telephones are included in a network environment, a large number of RJ-45 wires are necessary and therefore, a large wiring space is necessary.

### SUMMARY OF THE INVENTION

Accordingly, the primary object of the present invention is to provide an integrated IP network telephone distributor with switching and routing functions, wherein a telephone is connected to a computer for saving RJ-45 wires and the space for wiring arrangement is saved.

Another object of the present invention is to provide an integrated IP network telephone distributor with switching and routing functions, wherein the connecting ports required is saved and the requirement of hubs or network switching device is reduced.

A further object of the present invention is to provide an integrated IP network telephone distributor with switching and routing functions, wherein a Quality of Service (QoS) mechanism is present for assuring the bandwidth of the speech signal in a telephone.

To achieve above object, in the integrated IP network telephone distributor with switching and routing functions in accordance with the present invention, at least one network interface is provided for receiving and transmitting network packets. A memory device is provided for storing a package token lookup table and a package class lookup table. A packet classifying device is provided for comparing the network packet received by the at least one network interface with the package token lookup table and the packet class lookup table in the memory device to determine whether the received network packet is a voice package or a data package. The packet classifying device including an unpacketizing circuit, a token comparison circuit, a packet classifying circuit, and a switching and packetizing circuit. The unpacketizing circuit divides a network packet into a network packet header and a network packet data. The network packet data is stored in the memory device. The network packet header is sent to the token comparison circuit for performing a comparison process. The packet classifying circuit receives comparison result from the token comparison circuit for being compared with the packet class lookup table stored in the memory device for determining a class of the network packet. The switching and packetizing circuit performs switching and packetizing processes based on the class of the packet. If the packet is a voice packet, the network packet data in the memory device is read and sent to the voice processing circuit. If the network packet is a data package, the network packet data in the memory device is read and combined with the network packet header to form a network packet for being transferred to a connected computer through the at least one network interface. A voice processing circuit is provided for transforming the voice packet into voice signals for output.

The various objects and advantages of the present invention will be more readily understood from the following detailed description when read in conjunction with the appended drawing.

### BRIEF DESCRIPTION OF THE DRAWINGS

FIG. 1 is a functional block diagram of the integrated IP network telephone distributor with switching and routing functions in accordance with the present invention.

FIG. 2 is a schematic view of an integrated IP network telephone in accordance with the present invention.

FIG. 3 is a schematic view showing the connection of the integrated IP network telephone and computers in the present invention.

FIG. 4 is a schematic view showing that the integrated IP network telephone of the present invention is connected to the Internet.

### DETAILED DESCRIPTION OF THE PREFERRED EMBODIMENTS

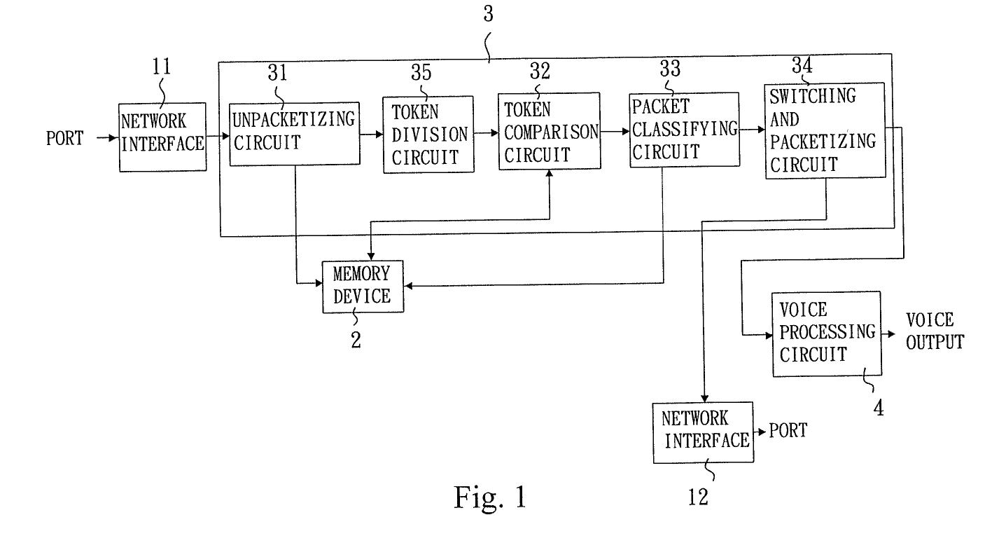

A preferred embodiment of the integrated IP network telephone distributor with switching and routing functions of the present invention is illustrated by using the Ethernet as an operating environment. Referring to the functional block diagram of FIG. 1, the integrated IP network telephone distributor includes two network interfaces 11 and 12, a memory device 2, a packet classifying device 3, and a voice processing circuit 4. The packet classifying device 3 includes an unpacketizing circuit 31, a token division circuit 35, a token comparison circuit 32, a packet classifying circuit 33, a switching and packetizing circuit 34.

The network interfaces 11 and 12 are implemented in two network cards, respectively, or integrated in one network interface card with two connecting ports, for receiving and transferring network packets. The memory device 2 includes a ready only memory (ROM) and a random access memory (RAM) for storing token lookup table, package class lookup table, and network packet data. Alternatively, the RAM can be replaced by a flash memory.

The packet classifying device 3 is implemented by ASIC for classifying the network packets received from the network interface 11, so as to recognize whether the received packet is a voice packet or a data packet. If the received packet is a voice packet, the packet is transferred to the voice processing circuit 4 for being processed and transformed to output voice signals. If the received packet is a data packet, the packet is transferred to a personal computer connected thereto.

When the integrated IP network telephone in this preferred embodiment receives a network packet from the Ethernet, the unpackizing circuit 31 in the packet classifying device 3 will divide the network packet into a network packet header having only header portion and a network packet data having only data portion. Then, the network packet data is sent to the memory device 2 for being temporarily stored. The network packet header is sent to the token division circuit 35.

A network packet typically has many fields. Therefore, when the token division circuit 35 receives the network packet header, each field in the network packet header capable of being used for classifying is taken out for being used as a token. The tokens are arranged sequentially as a sequence and the sequence is sent to the token comparison circuit 32 for performing a comparison process.

The token comparison circuit 32 compares the field of each token with the packet token lookup table stored in the memory device 2. The packet token lookup table has token rules, for example:

Field (Destination MAC Address Bytel);

Range (0×ff,0×13, . . . )

Value (0)

Range (0×00,0×12, . . . )

Value (1)

When the token comparison circuit 32 completes the comparison process, the result is sent to the packet classifying circuit 33 for being compared with the packet class lookup table in the memory device 2 to determine the class type of the received network packet. If the received packet is a voice packet, the switching and packetizing circuit 34 is notified to take out the network packet data in the memory device 2 for being transferred to the voice processing circuit 4 to perform a transformation process and thus output voice. If the received packet is not a voice packet, it is known that the network packet is a data packet. Then switching and packetizing circuit 34 reassembles the network packet header and the network packet data as a network packet for being sent out via the network interface 12.

The switching and packetizing circuit 34 can be set to reserve a predetermined bandwidth for transferring voice signals, thereby providing a QoS mechanism to assure a 64K bandwidth for the flow of the voice packet, so as to assure the quality of the voice communication.

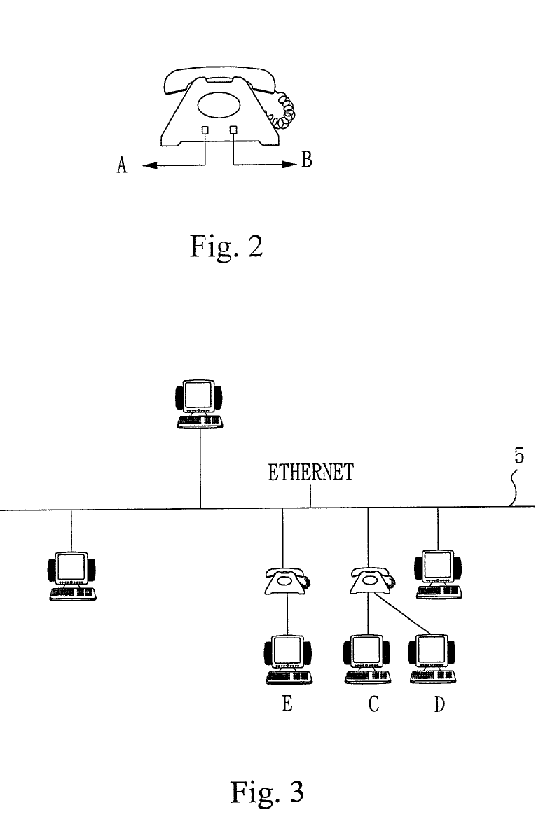

FIG. 2 is a schematic view of an integrated IP network telephone based on this preferred embodiment. The IP network telephone has two connecting ports, as denoted by A and B. Port A is connected to the Ethernet and port B is connected to a personal computer. Alternatively, more than two ports can be provided in the integrated IP network telephone for connecting more personal computers.

FIG. 3 is a schematic view showing that the integrated IP network telephone is connected to two personal computers. The two personal computers C and D are connect to other personal computers in the network only through the IP address of the integrated IP network telephone. When the network packet is received through the IP network telephone, the tokens in the network packet are used to determine which computer will receive the network packet.

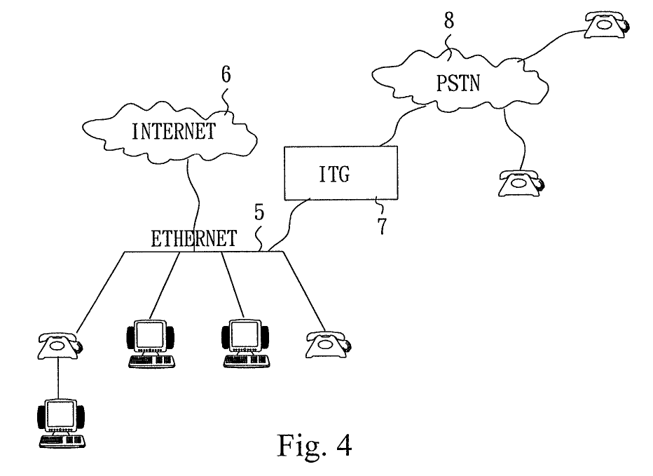

FIG. 4 shows that the integrated IP network telephone of this preferred embodiment is connected to a telephone in a public switching telephone network through an IP telephone gateway (ITG) by connecting the integrated IP network telephone to the Ethernet 5. Furthermore, the personal computer connected to the integrated IP network telephone of this preferred embodiment may be connected to other computers in the Internet.

In view of the foregoing, it is known that the present invention classifies the received network packet into a voice packet and a data packet used in general networks. The voice packet is transformed into voice signal through a voice processing circuit. The data packet is sent to a personal computer through a network interface. The switching and packetizing circuit in the packet classifying device has a QoS mechanism for reserving a voice bandwidth of 64K bps so as to have a satisfactory communication quality. Since the IP network telephone uses the same line as the computer, the RJ-45 line can be saved and thus the space for wiring a network is reduced. Moreover, the connecting port of a network can be arranged directly in an IP network telephone. The amount of the hubs and network switching device can be reduced greatly.

Although the present invention has been explained in relation to its preferred embodiment, it is to be understood that many other possible modifications and variations can be made without departing from the spirit and scope of the invention as hereinafter claimed.

What is claimed is:

1. An integrated IP network telephone distributor with switching and routing functions, comprising:
at least one network interface for receiving and transmitting network packets;
a memory device for storing a package token lookup table and a package class lookup table;
a packet classifying device for comparing the network packet received by the at least one network interface with the package token lookup table and the packet class lookup table in the memory device to determine whether the received network packet is a voice package or a data package, the packet classifying device including an unpacketizing circuit, a token comparison circuit, a packet classifying circuit, and a switching and packetizing circuit, the unpacketizing circuit serving for dividing a network packet into a network packet header and a network packet data, the network packet data being stored in the memory device, the network packet header being sent to the token comparison circuit for performing a comparison process, the packet classifying circuit receiving comparison result from the token comparison circuit for being compared with the packet class lookup table stored in the memory device for determining a class of the network packet, the switching and packetizing circuit performing switching and packetizing processes based on the class of the packet, wherein if the packet is a voice packet, the network packet data in the memory device is read and sent to the voice processing circuit, and if the network packet is a data package, the network packet data in the memory device is read and combined with the network packet header to form a network packet for being transferred to a connected computer through the at least one network interface; and
a voice processing circuit for transforming the voice packet into voice signals for output.

2. The integrated IP network telephone distributor with switching and routing functions as claimed in claim 1, wherein the packet classifying device has a token division circuit for taking out fields capable of being used for classifying in the network packet header, each field being used as a token, and the tokens are arranged sequentially as a sequence for being sent to the token comparison circuit.

3. The integrated IP network telephone distributor with switching and routing functions as claimed in claim 1, wherein the token comparison circuit compares the received tokens with the token lookup table in the memory device, and transfers a comparison result to the packet classifying circuit.

4. The integrated IP network telephone distributor with switching and routing functions as claimed in claim 1, wherein the switching and packetizing circuit reserves a transmission bandwidth of 64 Kbps for assuring a connection quality for voice communication.

5. The integrated IP network telephone distributor with switching and routing functions as claimed in claim 1, wherein the at least one network interface has a corresponding connecting port for connecting to a network and at least one computer.

6. The integrated IP network telephone distributor with switching and routing functions as claimed in claim 1, wherein the packet classifying device is implemented by application specific integrated circuit (ASIC).

7. The integrated IP network telephone distributor with switching and routing functions as claimed in claim 5, wherein the at least one computer requires only one IP address.

8. The integrated IP network telephone distributor with switching and routing functions as claimed in claim 1, wherein the packet classifying device classifies the package data of the at least one computer by using tokens in the network packet.
